(19) United States
(12) Patent Application Publication
(10) Pub. No.: US 2011/0144175 A1
(43) Pub. Date: Jun. 16, 2011

(54) METHOD FOR CONTROLLING DEGRADATION OF AGRICULTURAL CHEMICAL ACTIVE INGREDIENT

(75) Inventors: Takeshi Shindo, Shiga (JP); Hiromi Ohno, Shiga (JP); Yutaka Ishibashi, Shiga (JP)

(73) Assignee: ISHIHARA SANGYO KAISHA, LTD., Osaka-shi, Osaka (JP)

(21) Appl. No.: 13/059,243

(22) PCT Filed: Aug. 19, 2009
(86) PCT No.: PCT/JP2009/064811

§ 371 Date: Feb. 16, 2011

(30) Foreign Application Priority Data
Aug. 19, 2008 (JP) 2008-211054

(51) Int. Cl. A01N 43/50; A01P 3/00

(52) U.S. Cl. 514/400

(57) ABSTRACT

When Cyazofamid is formulated in accordance with a conventional formulation method, Cyazofamid is degraded in some cases. The problem to be solved by the present invention is to improve storage stability of the formulation by controlling degradation of Cyazofamid as an agricultural chemical active ingredient. The present invention provides a method for controlling degradation of an agricultural chemical active ingredient, Cyazofamid, which comprises using at least one stabilizer selected from the group consisting of epoxidized animal oil and/or vegetable oil, a nonionic surface active agent of polyoxyethylene, an anionic surface active agent of polyoxyethylene, polyhydric alcohol and a basic substance.

### TECHNICAL FIELD

This invention relates to a method for controlling degradation of an agricultural chemical active ingredient, Cyazofamid, which comprises using a specific stabilizer.

### BACKGROUND ART

Patent Literature 1 discloses an imidazole compound including Cyazofamid as an active ingredient in a composition for controlling harmful bio-organisms. Patent Literature 2 discloses an activity-enhanced composition for controlling harmful bio-organisms comprising an imidazole compound including Cyazofamid and an activity enhancing ingredient, such as surface active agents, mineral oil and animal and/or vegetable oil. In addition, both of the patent literatures disclose that the active ingredient can be formulated into various forms by blending various additive agents, such as an antifoaming agent, a stabilizer, a dispersing agent and a thickening agent. However, there is no description in these literatures about a method for controlling degradation of the agricultural chemical active ingredient, Cyazofamid, which comprises using at least one stabilizer selected from the group consisting of epoxidized animal and/or vegetable oil, a nonionic surface active agent of polyoxyethylene, an anionic surface active agent of polyoxyethylene, polyhydric alcohol and a basic substance.

### CITATION LIST

### Patent Literature

PTL 1: European Patent Publication No. 298196
PTL 2: International Publication WO 98/48628

### SUMMARY OF INVENTION

### Technical Problem

When Cyazofamid is formulated in accordance with a conventional formulation method, Cyazofamid is degraded in some cases. The problem to be solved by the present invention is to improve storage stability of the formulations by controlling degradation of Cyazofamid as an agricultural chemical active ingredient.

### Solution to Problem

As a result of investigations in order to solve the aforementioned problems, the present inventors have conducted studies and found that degradation of Cyazofamid as an agricultural chemical active ingredient can be controlled and its storage stability can therefore be improved when at least one stabilizer selected from the group consisting of epoxidized animal oil and/or vegetable oil, a nonionic surface active agent of polyoxyethylene, an anionic surface active agent of polyoxyethylene, polyhydric alcohol and a basic substance is blended in an agricultural chemical composition. That is, the present invention relates to a method for controlling degradation of an agricultural chemical active ingredient, Cyazofamid, which comprises using at least one stabilizer selected from the group consisting of epoxidized animal oil and/or vegetable oil, a nonionic surface active agent of polyoxyethylene, an anionic surface active agent of polyoxyethylene, polyhydric alcohol and a basic substance.

### Advantageous Effects of Invention

According to the method of the invention, the storage stability of an agricultural chemical composition comprising an agricultural chemical active ingredient, Cyazofamid, can be improved, and an agricultural composition in which Cyazofamid is chemically stabilized can be provided.

### DESCRIPTION OF EMBODIMENTS

Cyazofamid is a common name and its chemical name is 4-chloro-2-cyano-1-dimethylsulfamoyl-5-(4-methylphenyl)imidazole.

The epoxidized animal oil and/or vegetable oil to be used in the present invention as a stabilizer is a compound in which unsaturated bond moiety of fatty acids of animal oil and/or vegetable oil is epoxidized. Examples of the animal oil and/or vegetable oil herein includes vegetable oil, such as soybean oil, cotton seed oil, palm oil, linseed oil, rape seed oil, olive oil, corn oil, coconut oil and safflower oil; and animal oil, such as, beef tallow, lard and fish oil. Specific examples of the epoxidized animal and/or vegetable oil include epoxidized soybean oil (ESO), epoxidized linseed oil (ELO) and the like.

Examples of the nonionic surface active agent of polyoxyethylene to be used as a stabilizer in the present invention include polyoxyethylene alkyl ether, such as polyoxyethylene decyl ether, polyoxyethylene lauryl ether, polyoxyethylene cetyl ether, polyoxyethylene stearyl ether, polyoxyethylene oleyl ether, polyoxyethylene isodecyl ether, polyoxyethylene tridecyl ether, polyoxyethylene isostearyl ether, polyoxyethylene C₁₂₋₁₄ alkyl ether and polyoxyethylene C₂₀₋₄₀ alkyl ether; polyoxyethylene fatty acid ester, such as polyoxyethylene oleate ester, polyethylene glycol monolaurate, polyethylene glycol monostearate, polyethylene glycol monooleate and polyethylene glycol distearate; polyoxyethylene castor oil; and the like.

Examples of the anionic surface active agent of polyoxyethylene to be used as a stabilizer in the present invention include a salt of polyoxyethylene alkyl ether sulfuric acid ester, such as sodium polyoxyethylene lauryl ether sulfate, an ammonium salt of polyoxyethylene lauryl ether sulfuric acid ester, sodium polyoxyethylene alkyl ether sulfate and polyoxyethylene alkyl ether triethanolamine sulfate; polyoxyethylene alkylaryl ether sulfate; polyoxyethylene styryl ether sulfate; polyoxyethylene styryl ether ammonium sulfate; polyoxyethylene alkyl ether phosphate; a salt of polyoxyethylene alkylaryl ether phosphoric acid ester; polyoxyethylene styrylaryl ether phosphoric acid ester; a salt of polyoxyethylene styrylaryl ether phosphoric acid ester; and the like.

Examples of the polyhydric alcohol to be used in the present invention as a stabilizer include alcohols in which two or more of hydrogen atoms in the hydrocarbon moiety are substituted with hydroxyl groups. Specific examples include alkylene glycol (dihydric alcohol), such as ethylene glycol and propylene glycol; trihydric alcohol, such as glycerin; dialkylene glycol, such as diethylene glycol and dipropylene glycol; polyalkylene glycol, such as polyethylene glycol and polypropylene glycol.

Examples of the basic substance to be used in the present invention as a stabilizer include alkali metal hydroxides, such as sodium hydroxide and potassium hydroxide; alkali metal carbonates, such as sodium carbonate and potassium carbonate; alkali metal bicarbonates, such as sodium bicarbonate and potassium bicarbonate; alkaline earth metal hydroxides, such as calcium hydroxide and magnesium hydroxide; alkaline earth metal carbonates, such as calcium carbonate and magnesium carbonate; alkaline earth metal bicarbonate, such as calcium bicarbonate and magnesium bicarbonates; silicate aqueous solution, such as water glasses; basic silicates, such as sodium silicate and alkaline earth metal-basic silicate; and the like.

According to the present invention, Cyazofamid and a stabilizer are usually used at a weight ratio of from 1:100 to 100:1, preferably from 1:10 to 10:1.

According to the present invention, for example, an agricultural chemical active ingredient, Cyazofamid, and the aforementioned stabilizer can be formulated into various formulation forms, for example, a solid formulation, such as a dustable powder, a granule, a wettable powder, a water dispersible granule, a water soluble powder, a water soluble granule and a tablet; an emulsifiable concentrate; a soluble concentrate; a suspension concentrate; concentrated emulsion; suspoemulsion; microemulsion; emulsifiable gel; and the like, together with various additive agents for agricultural chemical formulations, and the agricultural chemical composition comprising Cyazofamid and a stabilizer (hereinafter referred to as agricultural chemical composition) formulated in this manner has considerably improved periodical stability of Cyazofamid. As the agricultural chemical composition of the present invention, a solid formulation is preferable. Among the solid formulations, a wettable powder, a water dispersible granule and a dustable powder are preferable.

The agricultural chemical composition of the present invention comprises for example, an agricultural chemical active ingredient, a stabilizer and a carrier, and can be formulated by mixing them. Examples of the carrier include solid carriers and fluid carriers. Examples of the solid carriers include animal and vegetable powders, such as starch, sugar, cellulose powders, cyclodextrin, activated charcoal, soybean powders, wheat powders, chaff powders, wood powders, fish powders and powdery milk; mineral powders, such as clay, talc, kaolin, bentonite, organic bentonite, calcium sulfate, zeolite, diatomaceous earth, white carbon, alumina, silica and sulfur powder; and the like. Examples of the fluid carriers include water; alcohols, such as ethyl alcohol and ethylene glycol; ketones, such as acetone and methyl ethyl ketone; ethers, such as dioxane and tetrahydrofran; aliphatic hydrocarbons, such as kerosene and lamp oil; aromatic hydrocarbons, such as toluene, xylene, trimethylbenzene, tetramethylbenzene, cyclohexane and solvent naphtha; halogenated hydrocarbons, such as chloroform and chlorobenzene; acid amides, such as dimethylformamide; esters, such as acetic acid ethyl ester and fatty acid glycerin ester; nitriles, such as acetonitrile; sulfur-containing compounds, such as dimethylsulfoxide; N-methyl-2-pyrrolidone; N,N-dimethylformamide; and the like. The carrier can be used by optionally selecting an appropriate substance depending on the formulation form. In this connection, when a basic substance is used as the stabilizer, it can also function as a carrier. Particularly, calcium carbonate is useful since it functions as both of a stabilizer and a carrier. Furthermore, in addition to the carrier, formulation adjuvants, such as an emulsifying agent, a suspension agent, a thickening agent, a dispersing agent, a wetting agent, an antifreezing agent and an antifoaming agent, can also be added to the agricultural chemical composition, if necessary.

Examples of the dispersing agent which can be used include an anionic surface active agent, such as naphthalene sulfonate, a salt of naphthalene sulfonic acid-formaldehyde condensate, alkylnaphthalene sulfonate, a salt of alkylnaphthalene sulfonic acid-formaldehyde condensate, phenol sulfonate, a salt of phenolsulfonic aid-formaldehyde condensate, lignin sulfonate and polycarboxylate; a nonionic surface active agent, such as oxyalkylene block polymer; and the like. In this connection, when a nonionic surface active agent of polyoxyethylene or an anionic surface active agent of polyoxyethylene is used as the stabilizer, it can also function as a dispersing agent. Examples of the wetting agent which can be used include dialkylnaphthalene sulfonate, an organic silicone wetting agent, alkyl phthalate, ethoxylated alkylamine and the like. In this connection, when a nonionic surface active agent of polyoxyethylene, an anionic surface active agent of polyoxyethylene or polyhydric alcohol is used as the stabilizer, it can also function as a wetting agent.

The Cyazofamid content as an agricultural chemical active ingredient in the agricultural chemical composition is usually from 0.1 to 70% by weight, preferably from 0.1 to 50% by weight, based on the total weight of the composition. The stabilizer content is usually from 0.05 to 20% by weight, preferably from 0.1 to 5% by weight, based on the total weight of the composition. The carrier content is usually from 10 to 99.85% by weight, preferably from 45 to 99.8% by weight, based on the total weight of the composition.

When a basic substance which can also function as a carrier is used as the stabilizer, regarding the content of each component in the agricultural chemical composition, the amount of the agricultural chemical active ingredient, Cyazofamid, can be set to usually from 0.1 to 70% by weight, preferably from 0.1 to 50% by weight, based on the total weight of the composition, and the amount of the basic substance which doubles both as a stabilizer and a carrier to usually from 30 to 99.9% by weight, preferably from 50 to 99.9% by weight, based on the total weight of the composition.

In addition, when a dispersing agent or wetting agent is added to the agricultural chemical composition, the dispersing agent content is usually from 0.5 to 20% by weight, preferably from 1 to 15% by weight, and the wetting agent content is usually from 0.5 to 10% by weight, preferably from 1 to 5% by weight, based on the total weight of the composition.

In addition to Cyazofamid, further one or more conventionally known other agricultural chemical active ingredient compounds, such as a fungicide, an insecticide, a mitecide, a nematocide, a soil insect pesticide, an antivirus agent, an attractant, a herbicide or a plant growth regulating agent, can also be blended and used in the agricultural chemical composition. In that case, it may show further superior effect. Among these other agricultural chemical active ingredient compounds, it is preferably combined with an active ingredient compound of fungicide. These other agricultural chemical active ingredient compounds can be used alone or as a mixture of two or more. When other agricultural chemical active ingredient compounds are blended in addition to Cyazofamid, the content of the other agricultural chemical active ingredient compounds is usually from 0.01 to 69.9% by weight, preferably from 0.1 to 30% by weight, based on the total weight of the composition.

The active ingredient compounds of the fungicide in the above-mentioned other agricultural chemicals include, for example, (by common names, some of them are still in an application stage, or test codes of Japan Plant Protection Association) anilinopyrimidine compounds such as mepanipyrim, pyrimethanil, cyprodinil and ferimzone; a triazoropyrimidine compound such as 5-chloro-6-(2,4,6-trifluorophenyl)-7-(4-methylpiperidin-1-yl) [1,2,4]triazolo[1,5-a]pyrimidine; pyridinamine compounds such as fluazinam; azole compounds such as triadimefon, bitertanol, triflumizole, etaconazole, propiconazole, penconazole, flusilazole, myclobutanil, cyproconazole, tebuconazole, hexaconazole, furconazole-cis, prochloraz, metconazole, epoxiconazole, tetraconazole, oxpoconazole fumarate, sipconazole, prothioconazole, triadimenol, flutriafol, difenoconazole, fluquinconazole, fenbuconazole, bromuconazole, diniconazole, tricyclazole, probenazole, simeconazole, pefurazoate, ipconazole and imibenconazole; quinoxaline compounds such as quinomethionate; dithiocarbamate compounds such as maneb, zineb, mancozeb, polycarbamate, metiram, propineb and thiram; organic chlorine compounds such as fthalide, chlorothalonil and quintozene, imidazole compounds such as benomyl, thiophanate-methyl, carbendazim, thiabendazole and fuberiazole; cyanoacetamide compounds such as cymoxanil; phenylamide compounds such as metalaxyl, metalaxyl-M, mefenoxam, oxadixyl, ofurace, benalaxyl, benalaxyl-M (another name: kiralaxyl, chiralaxyl), furalaxyl and cyprofuram; sulfenic acid compounds such as dichlofluanid; copper compounds such as cupric hydroxide and oxine copper; isoxazole compounds such as hymexazol; organophosphorus compounds such as fosetyl-Al, tolclofos-methyl, S-benzyl O,O-diisopropylphosphorothioate,O-ethyl S,S-diphenylphosphorodithioate, aluminum ethylhydrogen phosphonate, edifenphos, iprobenfos; N-halogenothioalkyl compounds such as captan, captafol and folpet; dicarboximide compounds such as procymidone, iprodione and vinclozolin; benzanilide compounds such as flutolanil, mepronil, zoxamid and tiadinil; anilide compounds such as carboxin, oxycarboxin, thifluzamide, penthiopyrad, boscalid, bixafen, fluopyram, isotianil and mixture of 2 syn-isomers 3-(difluoromethyl)-1-methyl-N[(1RS,4SR,9SR)-1,2,3,4-tetrahydro-9-isopropyl-1,4-methanonaphthalen-5-yl]pyrazole-4-carboxamide and 2 anti-isomers 3-(difluoromethyl)-1-methyl-N-[(1RS,4SR,9SR)-1,2,3,4-tetrahydro-9-isopropyl-1,4-methanonaphthalen-5-yl]pyrazole-4-carboxamide(isopyrazam); piperazine compounds such as triforine; pyridine compounds such as pyrifenox; carbinol compounds such as fenarimol and flutriafol; piperidine compounds such as fenpropidine, morpholine compounds such as fenpropimorph, spiroxamine and tridemorph; organotin compounds such as fentin hydroxide and fentin acetate; urea compounds such as pencycuron; cinnamic acid compounds such as dimethomorph and flumorph; phenylcarbamate compounds such as diethofencarb; cyanopyrrole compounds such as fludioxonil and fenpiclonil; strobilurin compounds such as azoxystrobin, kresoxim-methyl, metominofen, trifloxystrobin, picoxystrobin, oryzastrobin, dimoxystrobin, pyraclostrobin, and fluoxastrobin; oxazolidinone compounds such as famoxadone; thiazolecarboxamide compounds such as ethaboxam; silylamide compounds such as silthiopham; aminoacid amidecarbamate compounds such as iprovalicarb, benthiavalicarb-isopropyl, and methyl[S,(R,S)]-[(3-(N-isopopoxycarbonylvalinyl)-amino]-3-(4-chloro-phenyl)propaonate (valiphenal); imidazolidine compounds such as fenamidone; hydroxanilide compounds such as fenhexamid; benzenesulfonamide compounds such as flusulfamide; oxime ether compounds such as cyflufenamid; phenoxyamide compounds such as fenoxanil; anthraquinone compounds; crotonic compounds; antibiotics such as validamycin, kasugamycin and polyoxins; guanidine compounds such as iminoctadine and dodine; 4-quinolionol derivative compounds such as 2,3-dimethyl-6-t-butyl-8-fluoro-4-acetylquinoline; cyanomethylene compounds such as 2-(2-fluoro-5-(trifluoromethyl)phenylthio)-2-(3-(2-methoxyphenyl)thiazolidin-2-yliden)acetonitrile; and other compounds such as pyribencarb, isoprothiolane, Pyroquilon, diclomezine, quinoxyfen, propamocarb hydrochloride, chloropicrin, dazomet, metam-sodium, nicobifen, metrafenone, UBF-307, diclocymet, proquinazid, amisulbrom (another name: amibromdole), mandipropamid, fluopicolide, carpropamid, meptyldinocap, 6-t-butyl-8-fluoro-2,3-dimethylquinolin-4-yl acetate, BCF051, BCM061 and BCM062.

The active ingredient compounds of insect pest control agents, such as insecticides, miticides, nematicides or soil pesticides in the above-mentioned other agricultural chemicals, include, for example, (by common names, some of them are still in an application stage, or test codes of Japan Plant Protection Association) organic phosphate compounds such as profenofos, dichlorvos, fenamiphos, fenitrothion, EPN, diazinon, chlorpyrifos, chlorpyrifos-methyl, acephate, prothiofos, fosthiazate, cadusafos, dislufoton, isoxathion, isofenphos, ethion, etrimfos, quinalphos, dimethylvinphos, dimethoate, sulprofos, thiometon, vamidothion, pyraclofos, pyridaphenthion, pirimiphos-methyl, propaphos, phosalone, formothion, malathion, tetrachlovinphos, chlorfenvinphos, cyanophos, trichlorfon, methidathion, phenthoate, ESP, azinphos-methyl, fenthion, heptenophos, methoxychlor, paration, phosphocarb, demeton-5-methyl, monocrotophos, methamidophos, imicyafos, parathion-methyl, terbufos, phospamidon, phosmet and phorate; carbamate compounds such as carbaryl, propoxur, aldicarb, carbofuran, thiodicarb, methomyl, oxamyl, ethiofencarb, pirimicarb, fenobucarb, carbosulfan, benfuracarb, bendiocarb, furathiocarb, isoprocarb, metolcarb, xylylcarb, XMC and fenothiocarb; nereistoxin derivatives such as cartap, thiocyclam, bensultap and thiosultap-sodium; organic chlorine compounds such as dicofol, tetradifon, endosulufan, dienochlor and dieldrin; organic metal compounds such as fenbutatin oxide and cyhexatin; pyrethroid compounds such as fenvalerate, permethrin, cypermethrin, deltamethrin, cyhalothrin, tefluthrin, ethofenprox, flufenprox, cyfluthrin, fenpropathrin, flucythrinate, fluvalinate, cycloprothrin, lambda-cyhalothrin, pyrethrins, esfenvalerate, tetramethrin, resmethrin, protrifenbute, bifenthrin, zeta-cypermethrin, acrinathrin, alpha-cypermethrin, allethrin, gamma-cyhalothrin, theta-cypermethrin, tau-fluvalinate, tralomethrin, profluthrin, beta-cypermethrin, beta-cyfluthrin, metofluthrin, phenothrin, imidate and flumethrin; benzoylurea compounds such as diflubenzuron, chlorfluazuron, teflubenzuron, flufenoxuron, lufenuron, novaluron, triflumuron, hexaflumuron, bistrifluoron, noviflumuron, and fluazuron; juvenile hormone-like compounds such as methoprene, pyriproxyfen, fenoxycarb and diofenolan; pyridazinone compounds such as pridaben; pyrazole compounds such as fenpyroximate, fipronil, tebufenpyrad, ethiprole, tolfenpyrad, acetoprole, pyrafluprole and pyriprole; neonicotinoids such as imidacloprid, nitenpyram, acetamiprid, thiacloprid, thiamethoxam, clothianidin, nidinotefuran, and dinotefuran; hydrazine compounds such as tebufenozide, methoxyfenozide, chromafenozide and halofenozide; pyridine compounds such as pyridaryl and flonicamid; tetronic acid compounds such as spirodiclofen; strobilurin compounds such as fluacrypyrim; pyridinamine compounds such as flufenerim; dinitro compounds; organic sulfur compounds; urea compounds; triazine compounds; hydrazone compounds; and other compounds such as buprofezin, hexythiazox, amitraz, chlordimeform, silafluofen, triazamate, pymetrozine, pyrimidifen, chlorfenapyr, indoxacarb, acequinocyl, etoxazole, cyromazine, 1,3-dichloropropene, diafenthiuron, benclothiaz, bifenazate, spiromesifen, spirotetramat, propargite, clofentezine, metaflumizone, flubendiamide, cyflumetofen, chlorantraniliprole, cyenopyrafen, pyrifluquinazon, fenazaquin, pyridaben, amidoflumet, chlorobenzoate, sulfluramid, hydramethylnon, metaldehyde, HGW 86, ryanodine, flufenrim, pyridalyl, spirodiclofen, verbutin, thiazolylcinnanonitrile, AKD-1022, IKA-2000, and the like. Further, it may be used in combination with or together with microbial agricultural chemicals such as Bacillus thuringienses aizawai, Bacillus thuringienses kurstaki, Bacillus thuringienses israelensis, Bacillus thuringienses japonensis, Bacillus thuringienses tenebrionis, insecticidal crystal protein produced by Bacillus thuringienses, insect viruses, etomopathogenic fungi, and nematophagous fungi; antibiotics or semisynthetic antibiotics such as avermectin, emamectin-benzoate, milbemectin, milbemycin, spinosad, ivermectin, lepimectin, DE-175, abamectin, emamectin and spinetoram; natural products such as azadirachtin and rotenone; and repellents such as deet. It is further preferably used in combination with or together with benzanilide compound or an antibiotic among these active ingredient compounds of the fungicide.

When the agricultural chemical composition is a dustable powder or wettable powder, it is produced, for example, in the following manner. An agricultural chemical composition is produced by pulverizing a mixture of Cyazofamid, if necessary, with other agricultural chemical active ingredient, or a product of this further blended with a small amount of a carrier or the like, using a mixing mill for foods such as Millser (trade name, manufactured by Iwatani Corporation), a hammer mill, a pin mill, a jet mill, a centrifugal mill or the like, adding a carrier for obtaining a dustable powder or wettable powder and other ingredients, if necessary, and blending them using Ribbon Mixer, V-shape Mixer or the like, followed by further thoroughly blending them using an impact crusher or the like, if necessary. When the agricultural chemical composition is a water dispersible granule, it is produced by an extruding granulation method, a spray drying granulation method, and a fluidized bed granulation method.

Next, preferred embodiments of the present invention are described in the following.

(1) A method for controlling degradation of an agricultural chemical active ingredient, Cyazofamid, which comprises using at least one stabilizer selected from the group consisting of epoxidized animal oil and/or vegetable oil, a nonionic surface active agent of polyoxyethylene, an anionic surface active agent of polyoxyethylene, a polyhydric alcohol and a basic substance.
(2) The method described in (1), wherein the degradation of the agricultural chemical active ingredient, Cyazofamid, is controlled in a solid formulation.
(3) The method described in (2), wherein the solid formulation is a wettable powder, a water dispersible granule or a dustable powder.
(4) The method described in (2), wherein the solid formulation is a dustable powder.
(5) The method described in (1), wherein Cyazofamid and a stabilizer are used at a weight ratio of from 1:100 to 100:1.
(6) The method described in (1), wherein the stabilizer is epoxidized animal oil and/or vegetable oil.
(7) The method described in (6), wherein the epoxidized animal oil and/or vegetable oil is epoxidized soybean oil and/or epoxidized linseed oil.
(8) The method described in (1), wherein the nonionic surface active agent of polyoxyethylene is at least one selected from the group consisting of polyoxyethylene alkyl ether, polyoxyethylene fatty acid ester and polyoxyethylene castor oil.
(9) The method described in (1), wherein the nonionic surface active agent of polyoxyethylene is at least one selected from the group consisting of polyoxyethylene alkyl ether and polyoxyethylene fatty acid ester.
(10) The method described in (1), wherein the nonionic surface active agent of polyoxyethylene is at least one selected from the group consisting of polyoxyethylene lauryl ether and polyoxyethylene oleate ester.
(11) The method described in (1), wherein the anionic surface active agent of polyoxyethylene is at least one selected from the group consisting of a salt of polyoxyethylene alkyl ether sulfuric acid ester, polyoxyethylene alkylaryl ether sulfate, polyoxyethylene styryl ether sulfate, polyoxyethylene styryl ether ammonium sulfate, polyoxyethylene alkyl ether phosphate, a salt of polyoxyethylene alkylaryl ether phosphoric acid ester, polyoxyethylene styrylaryl ether phosphoric acid ester and a salt of polyoxyethylene styrylaryl ether phosphoric acid ester.
(12) The method described in (11), wherein the anionic surface active agent of polyoxyethylene is a salt of polyoxyethylene alkyl ether sulfuric acid ester.
(13) The method described in (12), wherein the salt of polyoxyethylene alkyl ether sulfuric acid ester is an ammonium salt of polyoxyethylene lauryl ether sulfuric acid ester.
(14) The method described in (11), (12) or (13), wherein polymerization degree of polyoxyethylene moiety of the anionic surface active agent of polyoxyethylene is from 3 to 30.
(15) The method described in (1), wherein the polyhydric alcohol is at least one selected from the group consisting of an alkylene glycol, a trihydric alcohol, a dialkylene glycol and a polyalkylene glycol.
(16) The method described in (15), wherein the polyhydric alcohol is at least one selected from the group consisting of a trihydric alcohol, a dialkylene glycol and a polyalkylene glycol.
(17) The method described in (16), wherein the polyhydric alcohol is at least one selected from the group consisting of glycerin and a diethylene glycol.
(18) The method described in (1), wherein the basic substance is at least one selected from the group consisting of an alkali metal hydroxide, an alkali metal carbonate, an alkali metal bicarbonate, an alkaline earth metal hydroxide, an alkaline earth metal carbonate and an alkaline earth metal bicarbonate.
(19) The method described in (1), wherein the basic substance is at least one selected from the group consisting of an alkali metal hydroxide, an alkali metal carbonate, an alkaline earth metal hydroxide and an alkaline earth metal bicarbonate.
(20) The method described in (1), wherein the basic substance is an alkali metal carbonate.
(21) An agricultural chemical composition, comprising an agricultural chemical active ingredient, Cyazofamid, and at least one stabilizer selected from the group consisting of epoxidized animal oil and/or vegetable oil, a nonionic surface active agent of polyoxyethylene, an anionic surface active agent of polyoxyethylene, polyhydric alcohol and a basic substance.
(22) The composition described in (21), which is a solid formulation.
(23) The composition described in (21), which is a wettable powder, a water dispersible granule or a dustable powder.
(24) The composition described in (21), which is a dustable powder.
(25) The composition described in (21), which is a wettable powder.
(26) The composition described in (21), wherein the stabilizer is epoxidized animal oil and/or vegetable oil.
(27) The composition described in (21), wherein the nonionic surface active agent of polyoxyethylene is at least one selected from the group consisting of polyoxyethylene alkyl ether, polyoxyethylene fatty acid ester and polyoxyethylene castor oil.
(28) The composition described in (21), wherein the anionic surface active agent of polyoxyethylene is at least one selected from the group consisting of a salt of polyoxyethylene alkyl ether sulfuric acid ester, polyoxyethylene alkylaryl ether sulfate, polyoxyethylene styryl ether sulfate, polyoxyethylene styryl ether ammonium sulfate, polyoxyethylene alkyl ether phosphate, a salt of polyoxyethylene alkylaryl ether phosphoric acid ester, polyoxyethylene styrylaryl ether phosphoric acid ester and a salt of polyoxyethylene styrylaryl ether phosphoric acid ester.
(29) The composition described in (21), wherein the polyhydric alcohol is at least one selected from the group consisting of an alkylene glycol, a trihydric alcohol, a dialkylene glycol and a polyalkylene glycol.
(30) The composition described in (21), wherein the basic substance is at least one selected from the group consisting of an alkali metal hydroxide, an alkali metal carbonate, an alkaline earth metal hydroxide and an alkaline earth metal bicarbonate.
(31) The composition described in (21) to (30), which comprises other agricultural chemical active ingredient, in addition to Cyazofamid.
(32) The composition described in (31), wherein the other agricultural chemical active ingredient is an active ingredient compound of a fungicide.
(33) The composition described in (32), wherein the active ingredient compound of a fungicide is a benzanilide compound or an antibiotic.
(34) The composition described in (32), wherein the active ingredient compound of a fungicide is a benzanilide compound.
(35) The composition described in (32), wherein the active ingredient compound of a fungicide is an antibiotic.

### EXAMPLES

### Example 1

After 50.0% by weight of MK clay (manufactured by Keiwa Rozai Co., Ltd.) and 1.6% by weight of a finely-milled Cyazofamid Technical (purity 94.4%, average particle diameter 2.32 μm) were weighed, they were blended using Millser. Further, 47.4% by weight of the above-mentioned MK clay and 1.0% by weight of a stabilizer were added thereto and again blended using Millser, thereby obtaining a dustable powder containing 1.5% by weight of Cyazofamid.

### Example 2

After 21.2% by weight of finely-milled Cyazofamid Technical (purity 94.4%, average particle diameter 2.32 μm), 8% by weight of a dispersing agent; a sodium alkylnaphthalenesulfonic acid-formaldehyde condensate (trade name: Supragil MNS/90), 2% by weight of a wetting agent; sodium dialkylnaphthalene sulfonate (trade name: Supragil WP) and 68.8% by weight of calcium carbonate LW-3000 (manufactured by Shimizu Industrial Corporation) are weighed, they are blended using Millser, thereby obtaining a wettable powder containing 20% by weight of Cyazofamid.

### Comparative Example

After 50.0% by weight of MK clay (manufactured by Keiwa Rozai Co., Ltd.) and 1.6% by weight of a finely-milled Cyazofamid Technical (purity 94.4%, average particle diameter 2.32 μm) were weighed, they were blended using Millser. Further, 48.4% by weight of the above-mentioned MK clay was added thereto and again blended using Millser, thereby obtaining a dustable powder containing 1.5% by weight of Cyazofamid.

### Test Example

The dustable powder obtained by Example 1 or Comparative Example was subjected to an accelerated preservation at 54° C. for 14 days, and then the Cyazofamid content in the dustable powder was measured by an HPLC (high performance liquid chromatography) and degradation ratio (%) of Cyazofamid was calculated by the following formula. The test results are shown in Table 1. In this connection, the Cyazofamid content in the dustable powder preserved at 4° C. was measured at the time of measuring the Cyazofamid content in the dustable powder after accelerated preservation, and the value was used as the initial stage content. Degradation ratio (%)=(initial stage content−content after accelerated preservation)/initial stage content×100

TABLE 1
(Degradation ratio of Cyazofamid)

| | | Degra- |
|---|---|---|
| | | dation |
| | | Ratio |
| | Stabilizer (1.0% by weight) | (%) |
| Example | Epoxidized Soybean Oil (trade name: NK 800: | 5 |
| | manufactured by TAKEMOTO OIL & FAT Co., | |
| | Ltd.) | |
| | Polyoxyethylene Lauryl Ether (trade name: Noigen | 6 |
| | ET-143: manufactured by Dai-ichi Kogyo Seiyaku | |
| | Co., Ltd.) | |
| | Polyoxyethylene Oleate Ester (trade name: Noigen | 5 |
| | ES-149: manufactured by Dai-ichi Kogyo Seiyaku | |
| | Co., Ltd.) | |
| | Polyoxyethylene Castor Oil (trade name: Sorpol | 7 |
| | CA20: manufactured by TOHO Chemical Industry | |
| | Co., Ltd.) | |
| | Ammonium Salt of Polyoxyethylene Lauryl Ether | 4 |
| | Sulfuric Acid Ester (trade name: Hitenol LA-12: | |
| | manufactured by Dai-ichi Kogyo Seiyaku Co., Ltd.) | |
| | Glycerin | 3 |
| | Diethylene Glycol | 9 |
| | 10% of Aqueous Sodium Carbonate Solution | 1 |
| Comparative | None | 84 |
| Example | | |

While the invention has been described in detail and with reference to specific embodiments thereof, it will be apparent to one skill in the art that various changes and modifications can be made therein without departing from the sprit and scope thereof.

This application is based on Japanese patent application No. 2008-211054 filed on Aug. 19, 2008, the entire contents of which are incorporated hereinto by reference. All references cited herein are incorporated in their entirety.

### INDUSTRIAL APPLICABILITY

According to the method of the invention, the storage stability of an agricultural chemical composition comprising an agricultural chemical active ingredient, Cyazofamid, can be improved, and an agricultural composition in which Cyazofamid is chemically stabilized can be provided.

1. A method for controlling degradation of an agricultural chemical active ingredient, Cyazofamid, which comprises using at least one stabilizer selected from the group consisting of epoxidized animal oil and/or vegetable oil, a nonionic surface active agent of polyoxyethylene, an anionic surface active agent of polyoxyethylene, a polyhydric alcohol and a basic substance.

2. The method according to claim 1, wherein the degradation of the agricultural chemical active ingredient, Cyazofamid, is controlled in a solid formulation.

3. The method according to claim 2, wherein the solid formulation is a wettable powder, a water dispersible granule or a dustable powder.

4. The method according to claim 1, wherein Cyazofamid and a stabilizer are used at a weight ratio of from 1:100 to 100:1.
